(19) United States
(12) Patent Application Publication
(10) Pub. No.: US 2017/0276903 A1
(43) Pub. Date: Sep. 28, 2017

(54) IMAGING LENS ASSEMBLY, IMAGING LENS MODULE AND ELECTRONIC DEVICE

(71) Applicant: LARGAN PRECISION CO., LTD., Taichung City (TW)

(72) Inventors: Ming-Shun Chang, Taichung City (TW); Chun-Hua Tsai, Taichung City (TW)

(21) Appl. No.: 15/165,023

(22) Filed: May 26, 2016

(30) Foreign Application Priority Data
Mar. 23, 2016 (TW) 105109032

(51) Int. Cl. G02B 13/00; G02B 23/24; G02B 27/00; G02B 5/00; G02B 7/02

(52) U.S. Cl. CPC G02B 13/003; G02B 5/003; G02B 7/02; G02B 27/0006; G02B 7/022; G02B 23/243

(57) ABSTRACT

An imaging lens assembly includes a dual molded lens barrel and at least one lens element. The dual molded lens barrel includes a light transmitting portion and a light absorbing portion. The light transmitting portion includes an effective optical section. The light absorbing portion is connected to the light transmitting portion, wherein a plastic material and a color of the light absorbing portion are different from a plastic material and a color of the light transmitting portion, and the light absorbing portion includes a barrel section. The lens element is disposed in the barrel section.

### RELATED APPLICATIONS

This application claims priority to Taiwan Application Serial Number 105109032, filed Mar. 23, 2016, which is herein incorporated by reference.

### BACKGROUND

Technical Field

The present disclosure relates to an imaging lens assembly and an imaging lens module. More particularly, the present disclosure relates to an imaging lens assembly and an imaging lens module which are applicable to portable electronic devices.

Description of Related Art

In recent years, with the popularity of mobile terminals having camera functionalities, the demand of miniaturized optical systems has been increasing. The sensor of a conventional optical system is typically a CCD (Charge-Coupled Device) or a CMOS (Complementary Metal-Oxide-Semiconductor) sensor. As the advanced semiconductor manufacturing technologies have allowed the pixel size of sensors to be reduced and compact optical systems have gradually evolved toward the field of higher megapixels, there is an increasing demand for compact optical systems featuring better image quality.

With the growing popularity of compact imaging lens modules, as well as the increasing sorts and applications of these compact imaging lens modules, many products have been equipped with compact imaging lens modules so as to be applied in the fields not only general photographing, but also medical devices, such as endoscopies. Hence, the specifications of compact imaging lens modules have become more demanding to satisfy the requirements of compact size, superior image quality, waterproof function and manufacturing conveniences.

However, conventional compact imaging lens modules cannot satisfy the strict requirements as previously mentioned, so there is an urgent need in developing an imaging lens module with the features of compact size, superior image quality, waterproof function and manufacturing conveniences.

### SUMMARY

According to one aspect of the present disclosure, an imaging lens assembly includes a dual molded lens barrel and at least one lens element. The dual molded lens barrel includes a light transmitting portion and a light absorbing portion. The light transmitting portion includes an effective optical section. The light absorbing portion is connected to the light transmitting portion, wherein a plastic material and a color of the light absorbing portion are different from a plastic material and a color of the light transmitting portion, and the light absorbing portion includes a barrel section. The lens element is disposed in the barrel section.

According to another aspect of the present disclosure, an electronic device includes an imaging lens module. The imaging lens module includes an imaging lens assembly according to the foregoing aspect and an image sensor. The image sensor is disposed in the light absorbing portion of the imaging lens assembly.

According to another aspect of the present disclosure, an imaging lens module includes a dual molded lens barrel and an image sensor. The dual molded lens barrel includes a light transmitting portion and a light absorbing portion. The light transmitting portion includes an effective optical section. The light absorbing portion is connected to the light transmitting portion, wherein a plastic material and a color of the light absorbing portion are different from a plastic material and a color of the light transmitting portion, and the light absorbing portion includes an imaging section. The image sensor is disposed in the imaging section.

According to another aspect of the present disclosure, an electronic device includes the imaging lens module according to the foregoing aspect.

### BRIEF DESCRIPTION OF THE DRAWINGS

FIG. 1A is a schematic view of an imaging lens assembly according to the 1st embodiment of the present disclosure;

FIG. 1B is a plane exploded view of the imaging lens assembly according to FIG. 1A;

FIG. 10 is a three-dimensional exploded view of the imaging lens assembly according to the 1st embodiment;

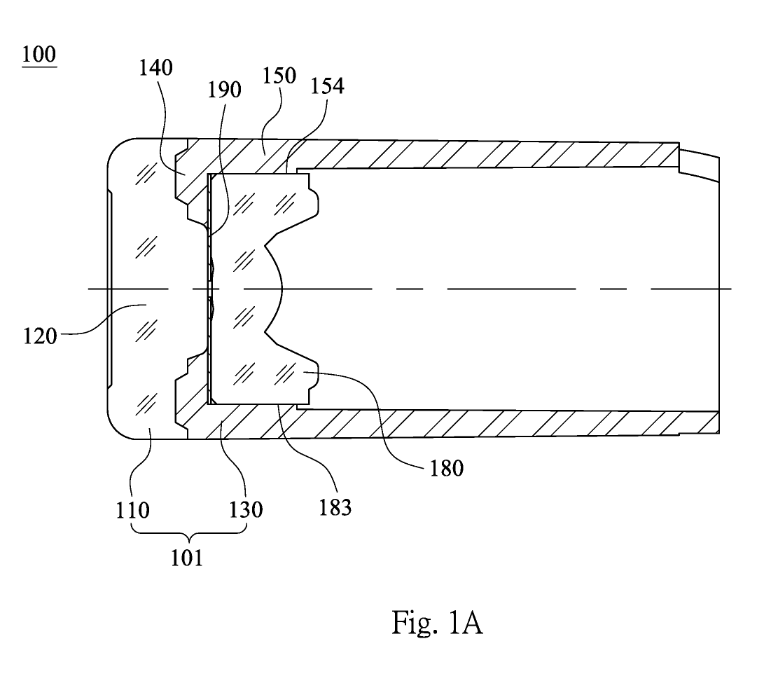

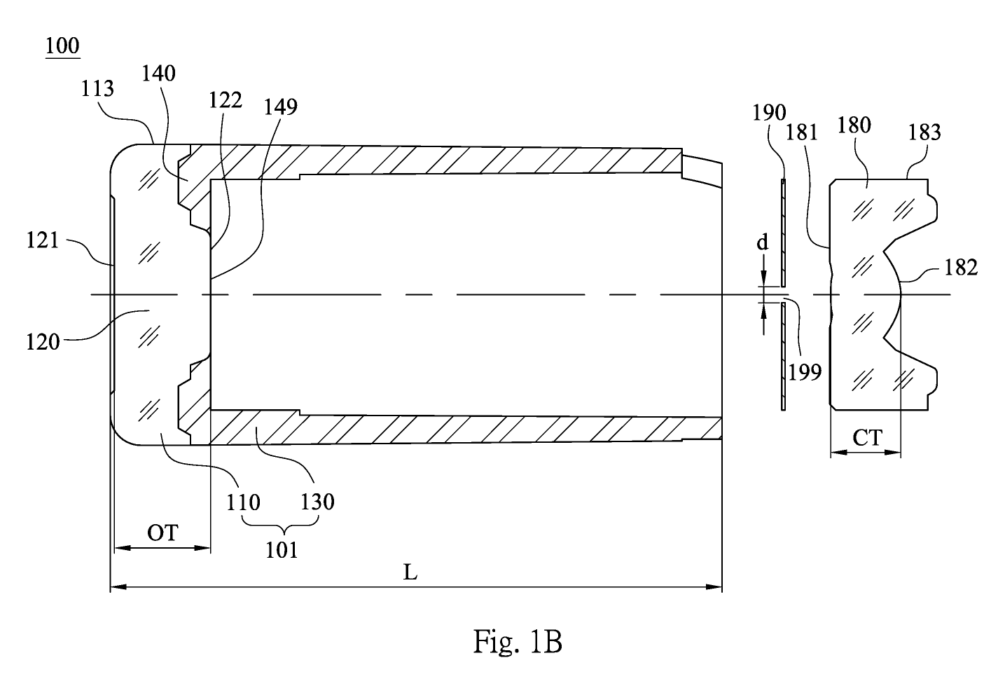

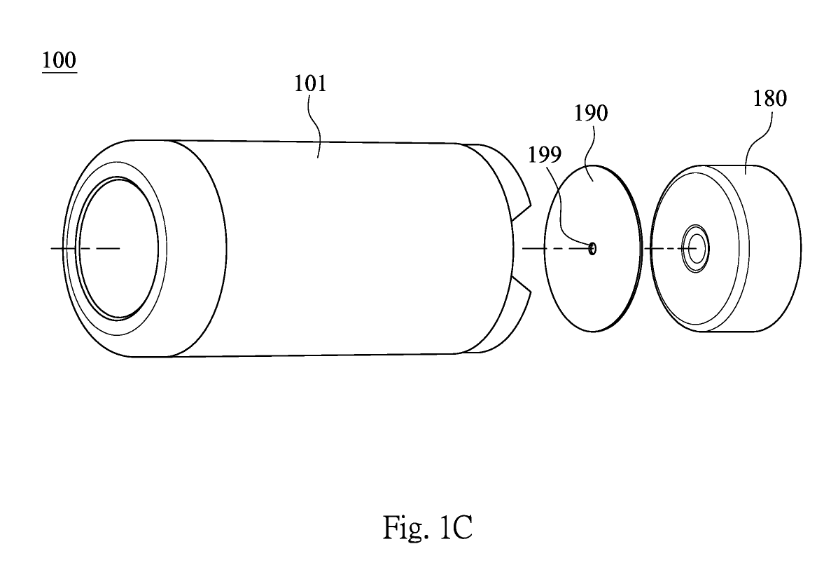

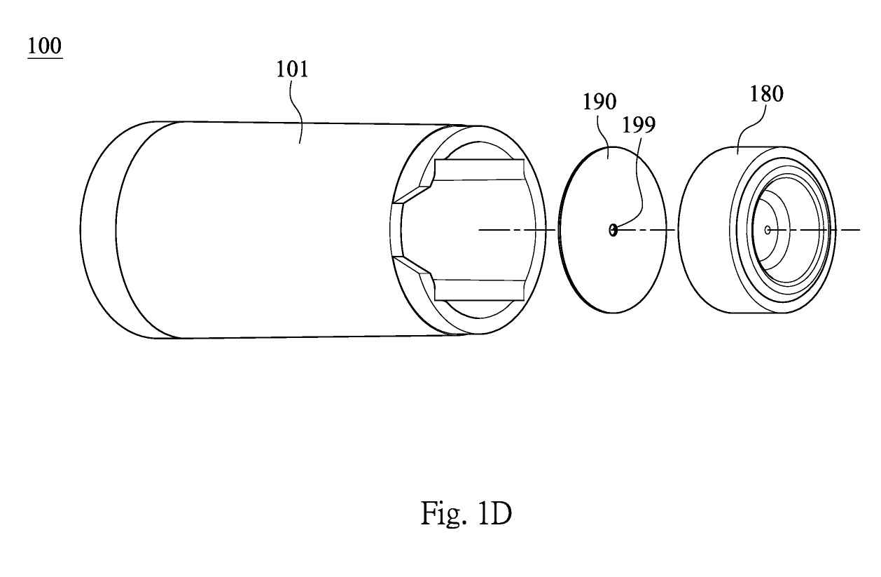

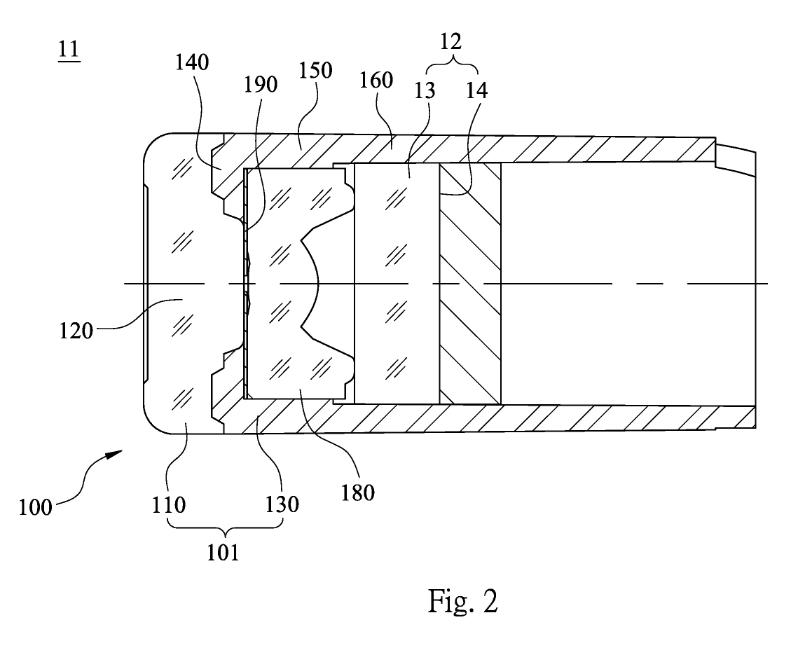

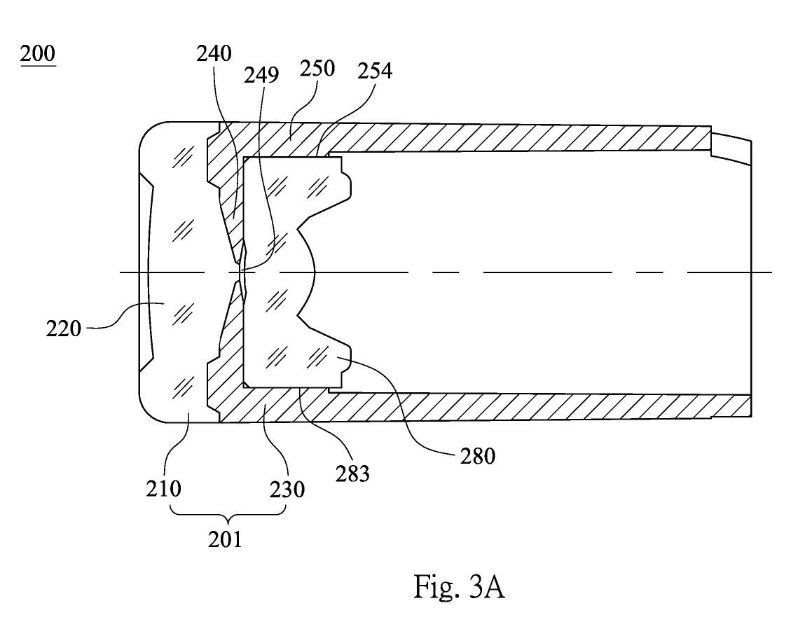

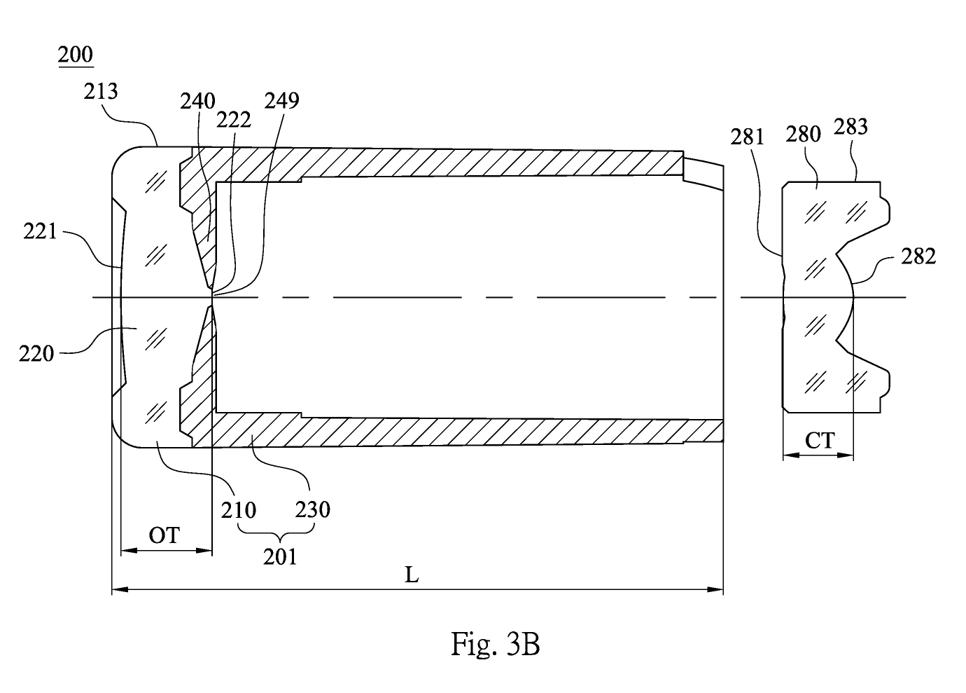

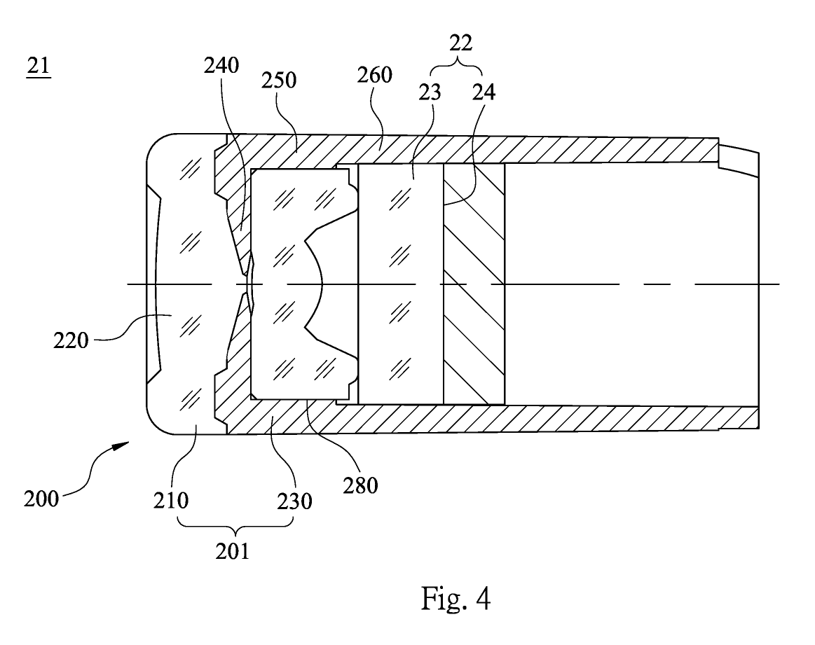

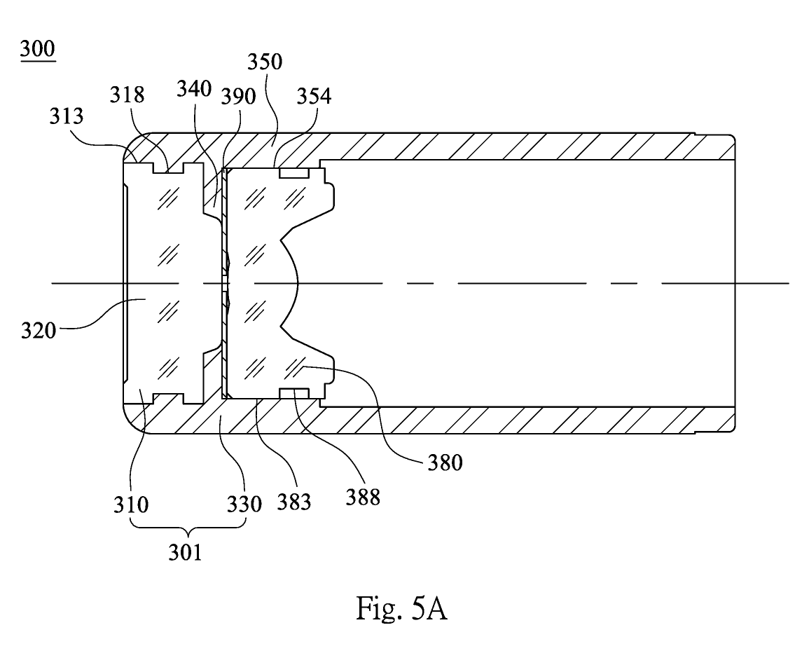

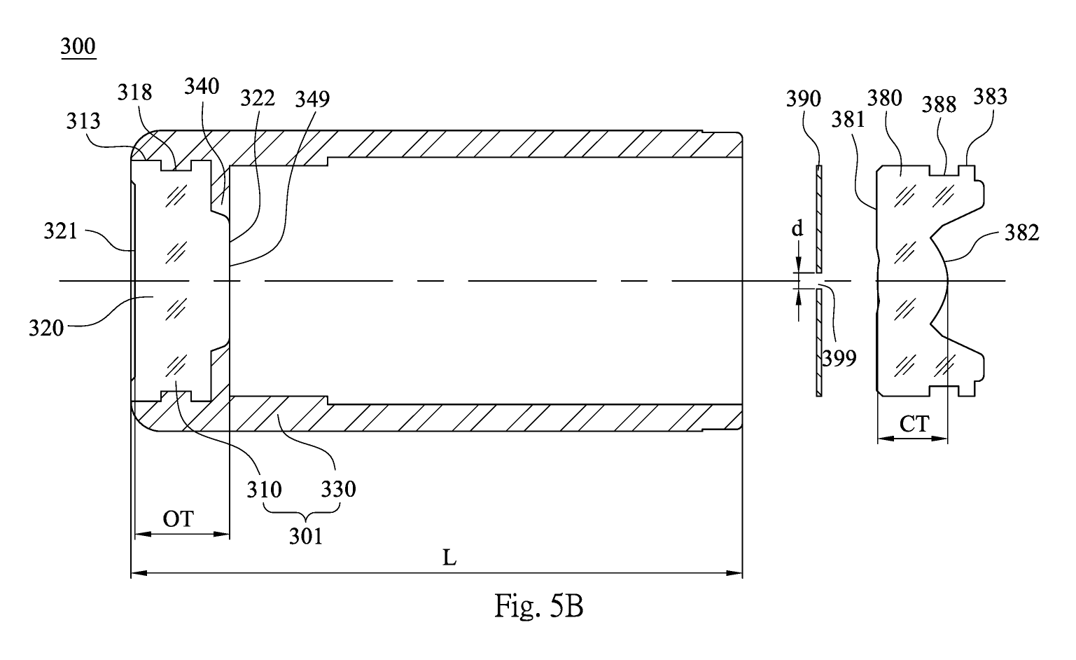

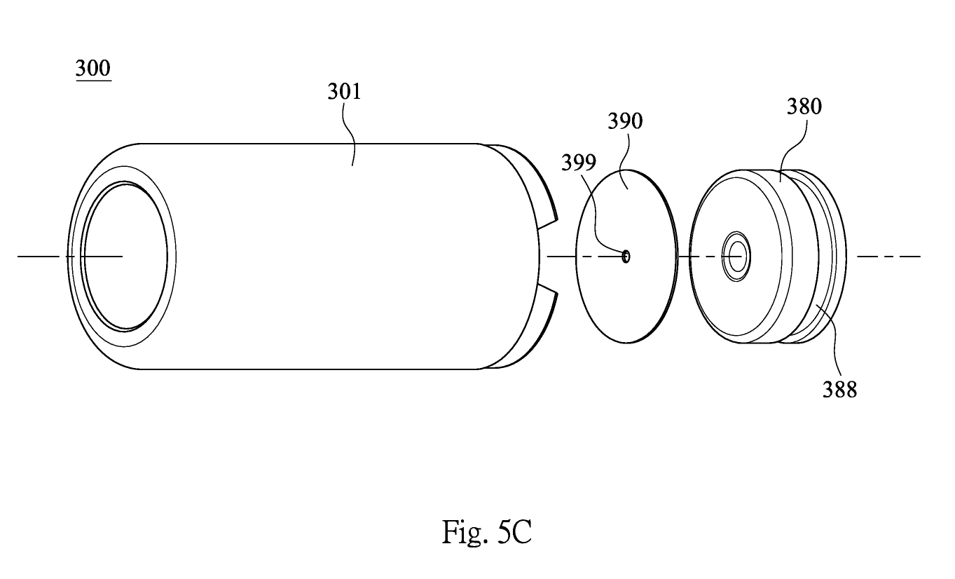

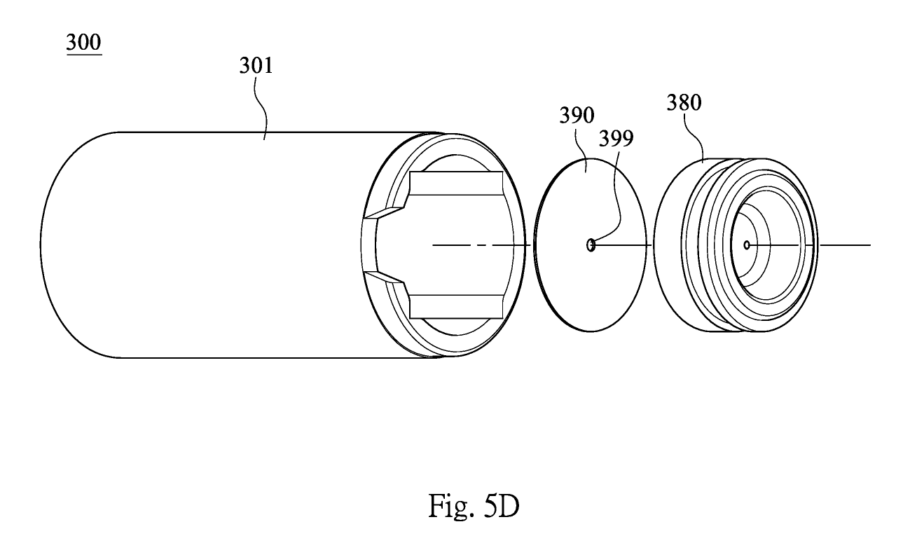

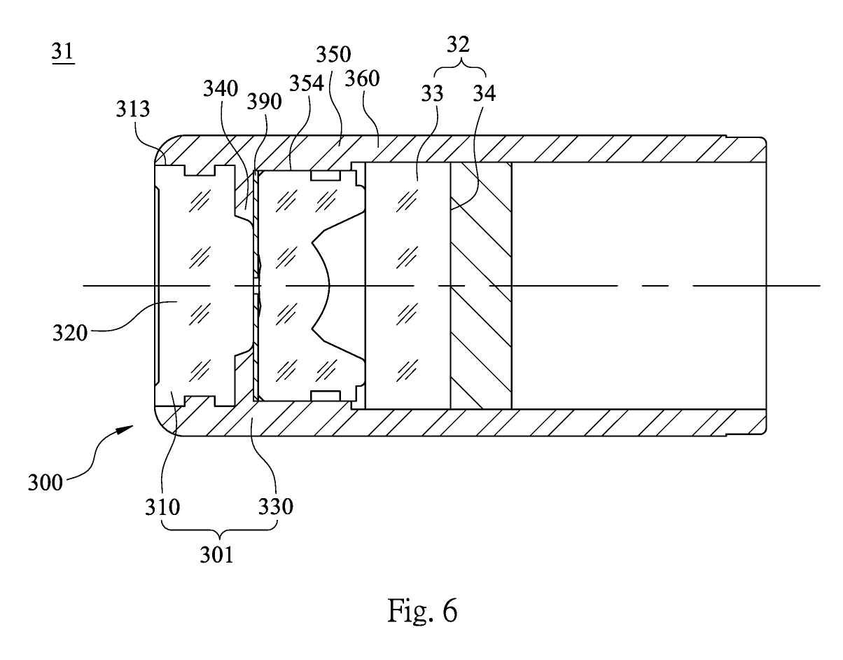

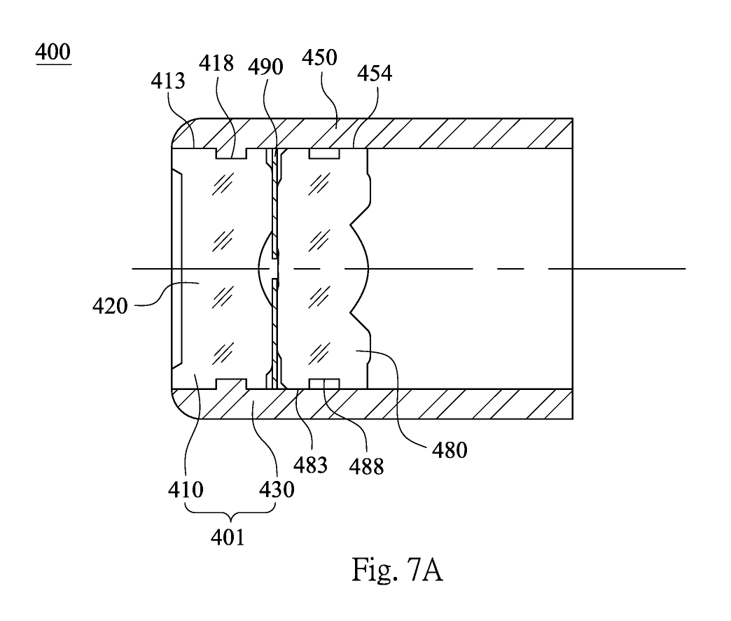

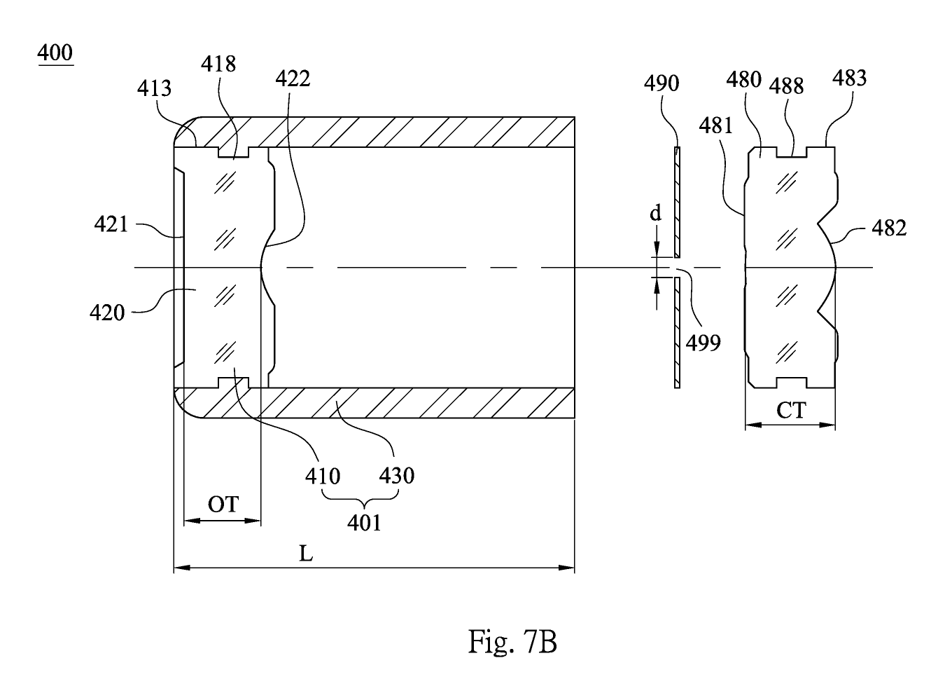

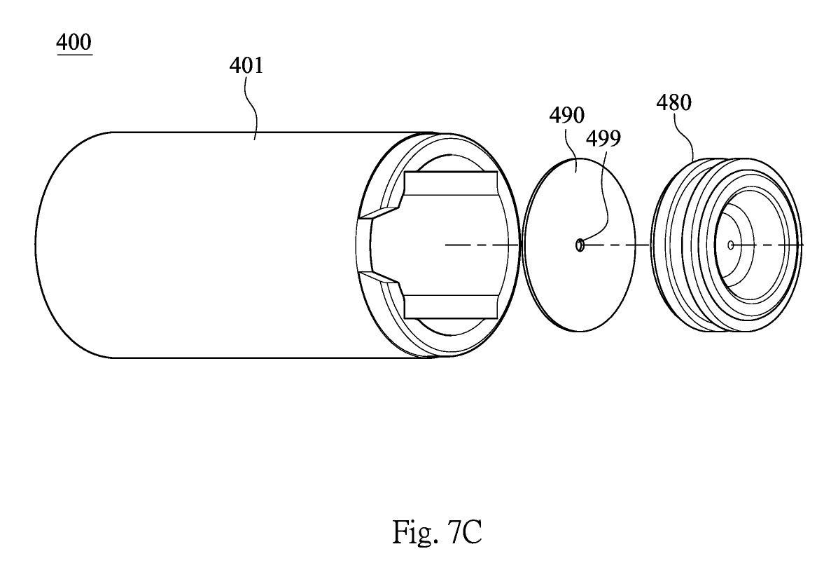

FIG. 1D is another three-dimensional exploded view of the imaging lens assembly according to the 1st embodiment;

FIG. 2 is a schematic view of an imaging lens module according to the 2nd embodiment of the present disclosure;

FIG. 3A is a schematic view of an imaging lens assembly according to the 3rd embodiment of the present disclosure;

FIG. 3B is a plane exploded view of the imaging lens assembly according to FIG. 3A;

FIG. 4 is a schematic view of an imaging lens module according to the 4th embodiment of the present disclosure;

FIG. 5A is a schematic view of an imaging lens assembly according to the 5th embodiment of the present disclosure;

FIG. 5B is a plane exploded view of the imaging lens assembly according to FIG. 5A;

FIG. 5C is a three-dimensional exploded view of the imaging lens assembly according to the 5th embodiment;

FIG. 5D is another three-dimensional exploded view of the imaging lens assembly according to the 5th embodiment;

FIG. 6 is a schematic view of an imaging lens module according to the 6th embodiment of the present disclosure;

FIG. 7A is a schematic view of an imaging lens assembly according to the 7th embodiment of the present disclosure;

FIG. 7B is a plane exploded view of the imaging lens assembly according to FIG. 7A;

FIG. 7C is a three-dimensional exploded view of the imaging lens assembly according to the 7th embodiment;

FIG. 8 is a schematic view of an imaging lens module according to the 8th embodiment of the present disclosure;

FIG. 9A is a schematic view of an imaging lens module according to the 9th embodiment of the present disclosure;

FIG. 9B is a plane exploded view of the imaging lens module according to FIG. 9A;

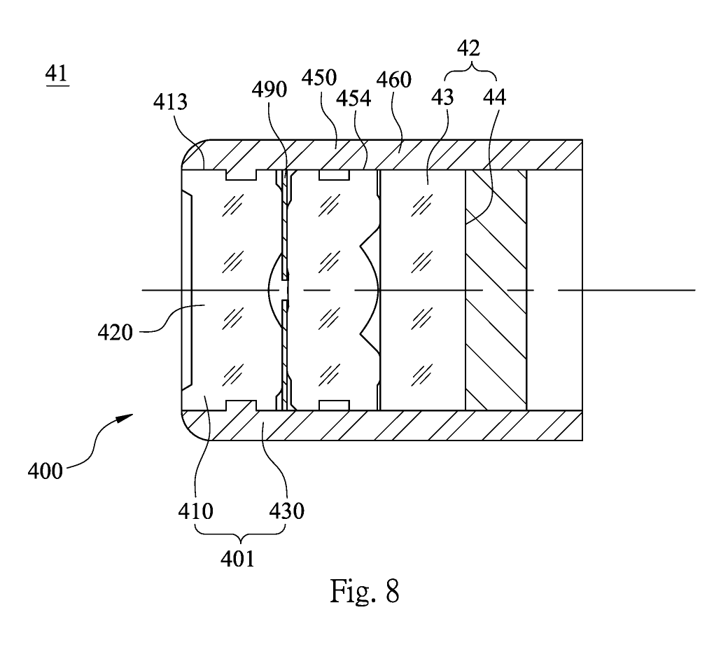

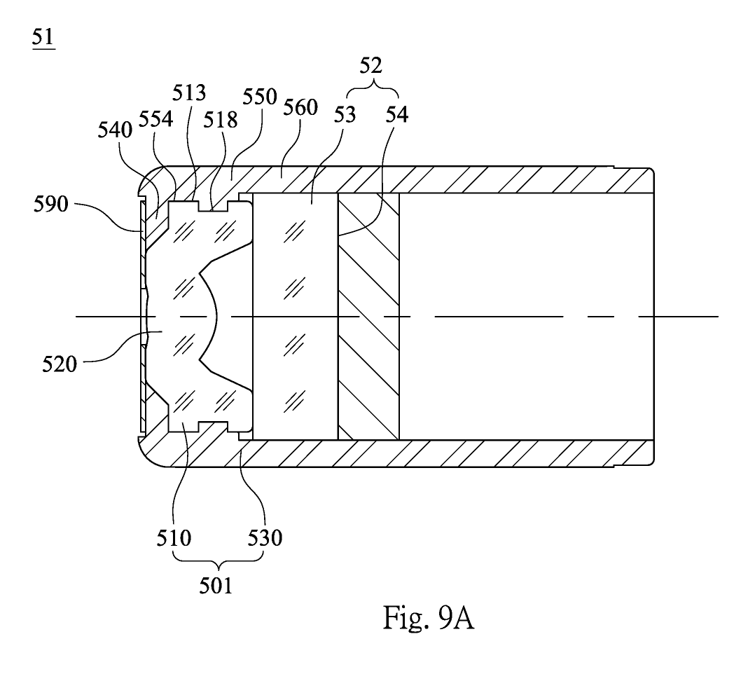

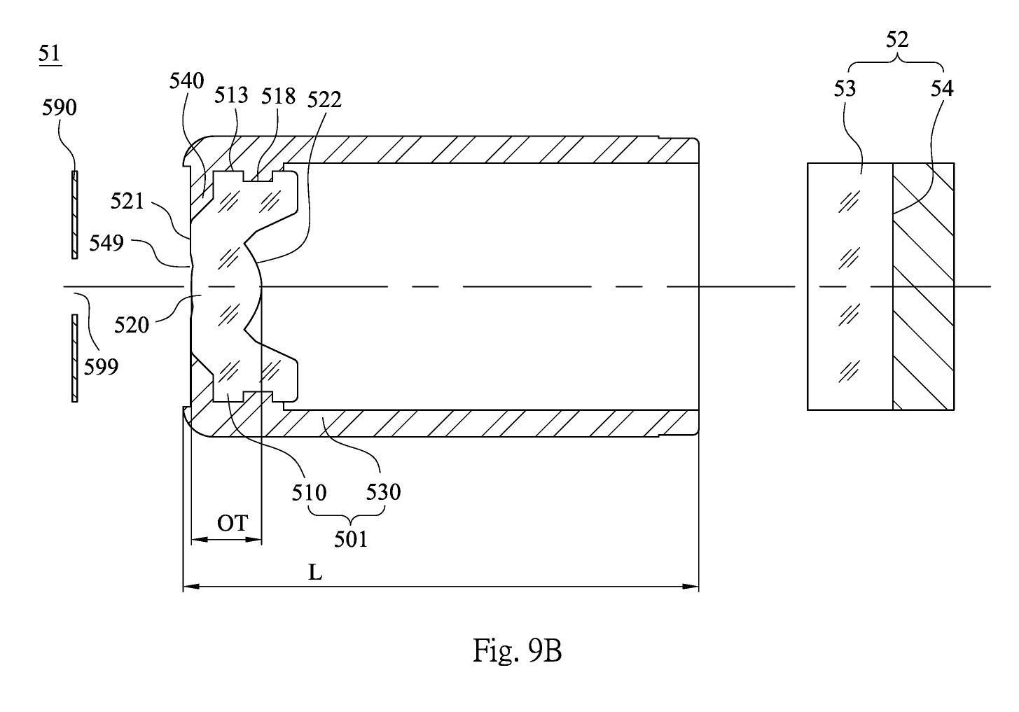

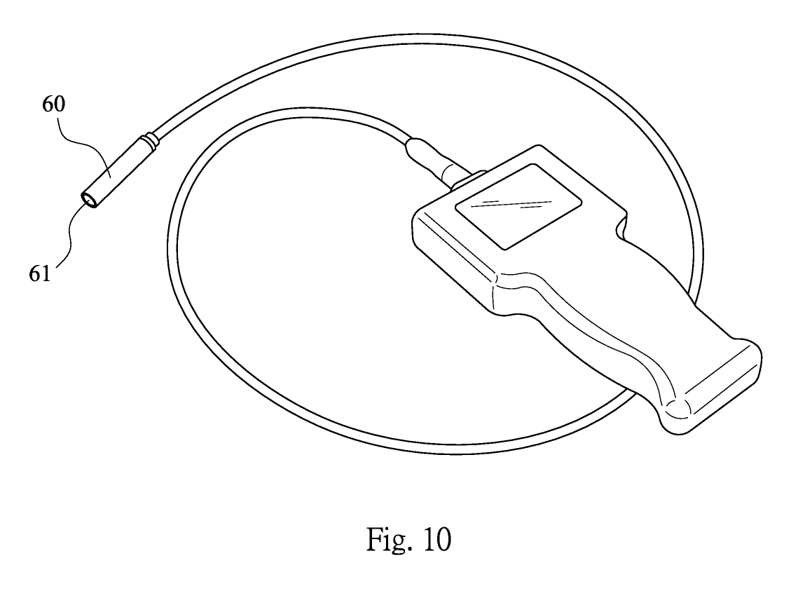

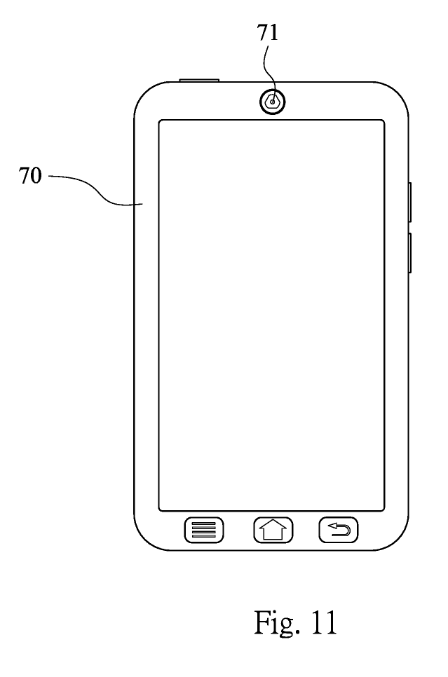

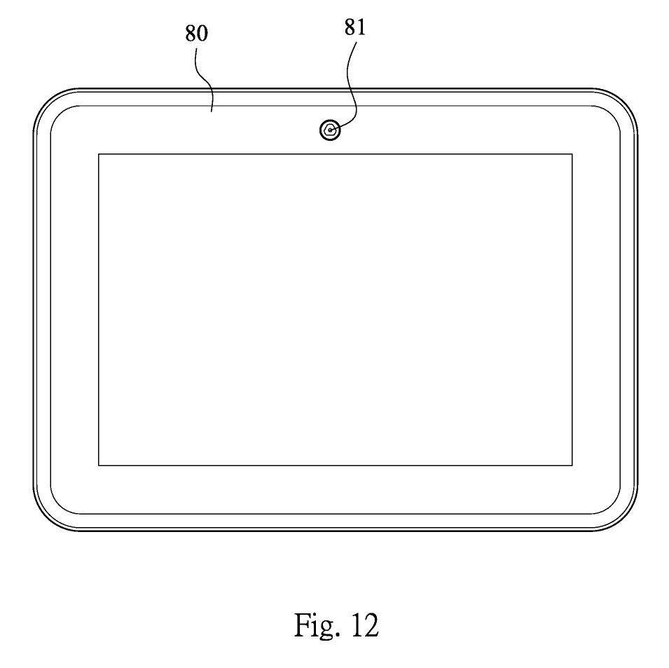

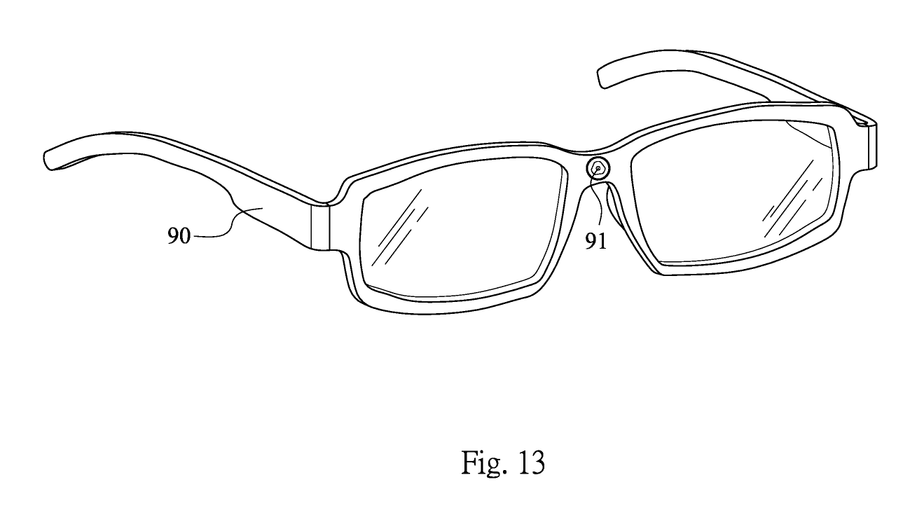

FIG. 10 shows an electronic device according to the 10th embodiment of the present disclosure;

FIG. 11 shows an electronic device according to the 11th embodiment of the present disclosure;

FIG. 12 shows an electronic device according to the 12th embodiment of the present disclosure; and

FIG. 13 shows an electronic device according to the 13th embodiment of the present disclosure.

### DETAILED DESCRIPTION

### 1st Embodiment

FIG. 1A is a schematic view of an imaging lens assembly 100 according to the 1st embodiment of the present disclosure. In FIG. 1A, the imaging lens assembly 100 includes a dual molded lens barrel 101 and at least one lens element 180.

The dual molded lens barrel 101 includes a light transmitting portion 110 and a light absorbing portion 130, wherein the light transmitting portion 110 and the light absorbing portion 130 of the dual molded lens barrel 101 are formed by a dual-shot injection molding method or a dual-shot molding method.

The light transmitting portion 110 includes an effective optical section 120, wherein an incident light passes through the effective optical section 120 and forms the image on an image surface (not shown herein). A term “effective optical section” indicates a section which the imaging light passes through. Each of an object-side surface and an image-side surface of the effective optical section can be a planar surface or a surface with any curvature, wherein blocking the effective optical section would affect imaging properties.

The light absorbing portion 130 is connected to the light transmitting portion 110, wherein a plastic material and a color of the light absorbing portion 130 are different from a plastic material and a color of the light transmitting portion 110. In the 1st embodiment, the light transmitting portion 110 is connected to a side facing an imaged object (not shown herein) of the light absorbing portion 130. The plastic material of the light absorbing portion 130 has the feature of absorbing visible light, and the color of the light absorbing portion 130 is black. The plastic material of the light transmitting portion 110 has the feature of being transmitted by visible light, and the color of the light transmitting portion 110 is transparent and colorless. Hence, the plastic material and the color of the light absorbing portion 130 are different from the plastic material and the color of the light transmitting portion 110. Furthermore, the light absorbing portion 130 includes a barrel section 150, wherein the lens element 180 is disposed in the barrel section 150. Therefore, it is favorable for maintaining the compact size and improving the image quality of the imaging lens assembly 100.

Conventionally, parts separately manufactured usually have different dimensional tolerances, so that a gap appears on a junction between parts after parts being assembled. The dual molded lens barrel 101 including the light transmitting portion 110 and the light absorbing portion 130 can be formed by the dual-shot injection molding method, so that the environmental fluid can be prevented from penetrating into the dual molded lens barrel 101, and the dual molded lens barrel 101 can have a waterproof function to maintain the quality reliability. Therefore, it is favorable for the imaging lens assembly 100 to be applicable to medical devices, such as endoscopies.

FIG. 1B is a plane exploded view of the imaging lens assembly 100 according to FIG. 1A. In FIG. 1B, when a length parallel to an axial axis of the dual molded lens barrel 101 is L, the following condition can be satisfied: 1.0 mm<L<7.5 mm. Therefore, it is favorable for maintaining the compact size and the manufacturability of the imaging lens assembly 100.

The light transmitting portion 110 and the light absorbing portion 130 can be formed by the dual-shot injection molding method. Therefore, it is favorable for reducing the complexity of mechanism design of the imaging lens assembly 100 and decreasing the manufacturing cost.

When a central thickness of the effective optical section 120 of the light transmitting portion 110 is OT, the following condition can be satisfied: 0.10 mm<OT<0.90 mm. Therefore, it is favorable for maintaining the compact size and the manufacturability of the imaging lens assembly 100. Furthermore, the effective optical section 120 of the light transmitting portion 110 has an object-side surface 121 being planar in a paraxial region and an image-side surface 122 being planar in a paraxial region, so that a range of the effective optical section 120 can be defined. Optical specifications of the imaging lens assembly 100 can be maintained when the size of the imaging lens assembly 100 is reduced. Optical specifications aforementioned can be field of view, but not limited thereto.

The light absorbing portion 130 can be passed through by an infrared light. When a transmittance of the light absorbing portion 130 for an incident light with a wavelength of 850 nm is T, the following condition can be satisfied: T>75%. Therefore, it is favorable for checking the molding homogeneity of the light absorbing portion 130 so as to process the birefringence of the light absorbing portion 130 more easily.

In FIG. 1A, an inner surface 154 of the barrel section 150 can be connected to an outer surface 183 of the lens element 180. That is, the lens element 180 can be disposed in the barrel section 150. Therefore, it is favorable for simplifying the assembling of the imaging lens assembly 100. In other embodiments (not shown herein), there can be more lens elements assembled in the barrel section, so that the imaging lens assembly can be used as a front lens assembly.

In FIG. 1B, when a central thickness of the lens element 180 is CT, the following condition can be satisfied: 0.12 mm<CT<0.90 mm. Therefore, it is favorable for maintaining the compact size and the manufacturability of the imaging lens assembly 100. In addition, the lens element 180 has an object-side surface 181 being convex in a paraxial region and an image-side surface 182 being convex in a paraxial region.

In FIG. 1A and FIG. 1B, the light absorbing portion 130 can further include a light blocking section 140, wherein a diameter of an opening 149 of the light blocking section 140 is smaller than a diameter of an outer surface 113 of the light transmitting portion 110. Therefore, it is favorable for properly enlarging the size of the imaging lens assembly 100 so as to simultaneously achieve compact size and dimensional stability of the imaging lens assembly 100 in production.

The imaging lens assembly 100 can further include a light blocking sheet 190 connected to the barrel section 150 of the light absorbing portion 130. Therefore, it is favorable for effectively blocking the stray light transmitted from the lens element 180. In the 1st embodiment, the light blocking sheet 190 is connected to and disposed in the barrel section 150.

The light blocking sheet 190 can be disposed between the effective optical section 120 of the light transmitting portion 110 and the lens element 180. Therefore, it is favorable for further effectively blocking the stray light transmitted from the lens element 180.

FIG. 10 is a three-dimensional exploded view of the imaging lens assembly 100 according to the 1st embodiment, and FIG. 1D is another three-dimensional exploded view of the imaging lens assembly 100 according to the 1st embodiment. In FIG. 1B, FIG. 10 and FIG. 1D, an opening 199 of the light blocking sheet 190 can be an aperture stop of the imaging lens assembly 100. Therefore, it is favorable for reducing the complexity of mechanism design of the imaging lens assembly 100 so as to satisfy the requirements of compact size.

In FIG. 1B, when a diameter of the opening 199 of the light blocking sheet 190 is d, the following condition can be satisfied: 0.02 mm<d<0.15 mm. Therefore, it is favorable for effectively controlling the incoming light of the imaging lens assembly 100 so as to balance the optical specifications and the image quality.

The data of the aforementioned parameters of the imaging lens assembly 100 according to the 1st embodiment of the present disclosure are listed in the following Table 1, wherein the parameters are also shown as FIG. 1B.

TABLE 1
1st Embodiment

| | |
|---|---|
| CT (mm) | 0.35 |
| L (mm) | 3.051 |
| OT (mm) | 0.48 |

### 2nd Embodiment

FIG. 2 is a schematic view of an imaging lens module 11 according to the 2nd embodiment of the present disclosure. In FIG. 2, the imaging lens module 11 includes the imaging lens assembly 100 in the aforementioned 1st embodiment and an image sensor 12. The image sensor 12 is disposed in the light absorbing portion 130 of the dual molded lens barrel 101 of the imaging lens assembly 100. Therefore, it is favorable for maintaining the compact size and improving the image quality of the imaging lens module 11.

In FIG. 2 and the aforementioned 1st embodiment, the imaging lens module 11 includes the dual molded lens barrel 101 and the image sensor 12. The dual molded lens barrel 101 includes the light transmitting portion 110 and the light absorbing portion 130. The light transmitting portion 110 includes the effective optical section 120. The light absorbing portion 130 is connected to the light transmitting portion 110, wherein the plastic material and the color of the light absorbing portion 130 are different from the plastic material and the color of the light transmitting portion 110, and the light absorbing portion 130 includes an imaging section 160. The image sensor 12 is disposed in the imaging section 160. Therefore, it is favorable for maintaining the compact size and improving the image quality of the imaging lens module 11. In the 2nd embodiment, the image sensor 12 includes a cover glass 13 and an image surface 14, wherein the cover glass 13 is nearer an imaged object (not shown herein) than the image surface 14.

In detail, when the length parallel to the axial axis of the dual molded lens barrel 101 is L, and the following condition can be satisfied: 1.0 mm<L<7.5 mm. Therefore, it is favorable for maintaining the compact size and the manufacturability of the imaging lens module 11.

In FIG. 2, the light transmitting portion 110 and the light absorbing portion 130 can be formed by the dual-shot injection molding method. Therefore, it is favorable for reducing the complexity of mechanism design of the imaging lens module 11 and decreasing the manufacturing cost.

In FIG. 1B, when the central thickness of the effective optical section 120 of the light transmitting portion 110 is OT, the following condition can be satisfied: 0.10 mm<OT<0.90 mm. Therefore, it is favorable for maintaining the compact size and the manufacturability of the imaging lens module 11.

In FIG. 1B and FIG. 2, the light absorbing portion 130 can further include the barrel section 150. The imaging lens module 11 can further include the at least one lens element 180 disposed in the barrel section 150.

The light absorbing portion 130 can further include the light blocking section 140, wherein the diameter of the opening 149 of the light blocking section 140 is smaller than the diameter of the outer surface 113 of the light transmitting portion 110. Therefore, it is favorable for properly enlarging the size of the imaging lens module 11 so as to achieve the dimensional stability of the imaging lens module 11 in production.

The imaging lens module 11 can further include the light blocking sheet 190 connected to the barrel section 150 of the light absorbing portion 130, wherein the opening 199 of the light blocking sheet 190 can be an aperture stop of the imaging lens module 11. Therefore, it is favorable for effectively blocking the stray light transmitted from the lens element 180.

The data of the aforementioned parameters of the imaging lens module 11 according to the 2nd embodiment of the present disclosure are listed in the following Table 2, wherein the parameters are also shown as FIG. 1B.

TABLE 2
2nd Embodiment

| | |
|---|---|
| L (mm) | 3.051 |
| OT (mm) | 0.48 |

The other details of the imaging lens assembly 100 have been described in the foregoing paragraphs of the 1st embodiment and will not be described again herein.

### 3rd Embodiment

FIG. 3A is a schematic view of an imaging lens assembly 200 according to the 3rd embodiment of the present disclosure. In FIG. 3A, the imaging lens assembly 200 includes a dual molded lens barrel 201 and at least one lens element 280.

The dual molded lens barrel 201 includes a light transmitting portion 210 and a light absorbing portion 230. The light transmitting portion 210 includes an effective optical section 220, wherein an incident light passes through the effective optical section 220 and forms the image on an image surface (not shown herein).

The light absorbing portion 230 is connected to the light transmitting portion 210, wherein the light transmitting portion 210 is connected to a side facing an imaged object (not shown herein) of the light absorbing portion 230. A plastic material of the light absorbing portion 230 has the feature of absorbing visible light, and a color of the light absorbing portion 230 is black. A plastic material of the light transmitting portion 210 has the feature of being transmitted by visible light, and a color of the light transmitting portion 210 is transparent and colorless. Hence, the plastic material and the color of the light absorbing portion 230 are different from the plastic material and the color of the light transmitting portion 210. Furthermore, the light absorbing portion 230 includes a barrel section 250, wherein the lens element 280 is disposed in the barrel section 250.

In detail, the dual molded lens barrel 201 has a waterproof function. The light transmitting portion 210 and the light absorbing portion 230 are formed by a dual-shot injection molding method.

FIG. 3B is a plane exploded view of the imaging lens assembly 200 according to FIG. 3A. In FIG. 3B, at least one surface of an object-side surface 221 and an image-side surface 222 of the effective optical section 220 of the light transmitting portion 210 has diopter. Therefore, it is favorable for correcting aberrations of the imaging lens assembly 200. In the 3rd embodiment, both of the object-side surface 221 and the image-side surface 222 of the effective optical section 220 of the light transmitting portion 210 have diopter, wherein the object-side surface 221 is convex in a paraxial region, and the image-side surface 222 is concave in a paraxial region.

The surface having diopter of the object-side surface 221 and the image-side surface 222 of the effective optical section 220 of the light transmitting portion 210 can be aspheric. Therefore, it is favorable for enhancing the image resolution of the imaging lens assembly 200. In the 3rd embodiment, both of the object-side surface 221 having diopter and the image-side surface 222 having diopter are aspheric.

In FIG. 3A and FIG. 3B, the light absorbing portion 230 can be passed through by an infrared light. When a transmittance of the light absorbing portion 230 for an incident light with a wavelength of 850 nm is T, the following condition is satisfied: T>75%. An inner surface 254 of the barrel section 250 is connected to an outer surface 283 of the lens element 280. That is, the lens element 280 is disposed in the barrel section 250. In addition, the lens element 280 has an object-side surface 281 being convex in a paraxial region and an image-side surface 282 being convex in a paraxial region.

The light absorbing portion 230 further includes a light blocking section 240, wherein a diameter of an opening 249 of the light blocking section 240 is smaller than a diameter of an outer surface 213 of the light transmitting portion 210.

The opening 249 of the light blocking section 240 is an aperture stop of the imaging lens assembly 200. Therefore, it is favorable for reducing the component number and simplifying the production process of the imaging lens assembly 200.

The data of the parameters CT, L and OT of the imaging lens assembly 200 according to the 3rd embodiment of the present disclosure are listed in the following Table 3, wherein the parameters are also shown as FIG. 3B. The definitions of these parameters shown in Table 3 are the same as those stated in the 1st embodiment with corresponding values for the 3rd embodiment.

TABLE 3
3rd Embodiment

| | |
|---|---|
| CT (mm) | 0.35 |
| L (mm) | 3.051 |
| OT (mm) | 0.455 |

### 4th Embodiment

FIG. 4 is a schematic view of an imaging lens module 21 according to the 4th embodiment of the present disclosure. In FIG. 4, the imaging lens module 21 includes the imaging lens assembly 200 in the aforementioned 3rd embodiment and an image sensor 22. The image sensor 22 is disposed in the light absorbing portion 230 of the dual molded lens barrel 201 of the imaging lens assembly 200.

In FIG. 4 and the aforementioned 3rd embodiment, the imaging lens module 21 includes the dual molded lens barrel 201 and the image sensor 22. The dual molded lens barrel 201 includes the light transmitting portion 210 and the light absorbing portion 230. The light transmitting portion 210 includes the effective optical section 220. The light absorbing portion 230 is connected to the light transmitting portion 210, wherein the plastic material and the color of the light absorbing portion 230 are different from the plastic material and the color of the light transmitting portion 210, and the light absorbing portion 230 includes an imaging section 260. The image sensor 22 is disposed in the imaging section 260. The image sensor 22 includes a cover glass 23 and an image surface 24, wherein the cover glass 23 is nearer an imaged object (not shown herein) than the image surface 24.

In FIG. 3B and FIG. 4, the light transmitting portion 210 and the light absorbing portion 230 are formed by the dual-shot injection molding method.

At least one surface of the object-side surface 221 and the image-side surface 222 of the effective optical section 220 of the light transmitting portion 210 has diopter. Therefore, it is favorable for correcting aberrations of the imaging lens module 21. In the 4th embodiment, both of the object-side surface 221 and the image-side surface 222 of the effective optical section 220 of the light transmitting portion 210 have diopter, wherein the object-side surface 221 is convex in the paraxial region, and the image-side surface 222 is concave in the paraxial region.

The surface having diopter of the object-side surface 221 and the image-side surface 222 of the effective optical section 220 of the light transmitting portion 210 can be aspheric. Therefore, it is favorable for enhancing the image resolution of the imaging lens module 21. In the 4th embodiment, both of the object-side surface 221 having diopter and the image-side surface 222 having diopter are aspheric.

The light absorbing portion 230 further includes the barrel section 250. The imaging lens module 21 further includes the at least one lens element 280 disposed in the barrel section 250.

The light absorbing portion 230 further includes the light blocking section 240, wherein the diameter of the opening 249 of the light blocking section 240 is smaller than the diameter of the outer surface 213 of the light transmitting portion 210.

The opening 249 of the light blocking section 240 is an aperture stop of the imaging lens module 21. Therefore, it is favorable for reducing the component number and simplifying the production process of the imaging lens module 21.

The data of the parameters L and OT of the imaging lens module 21 according to the 4th embodiment of the present disclosure are listed in the following Table 4, wherein the parameters are also shown as FIG. 3B. The definitions of these parameters shown in Table 4 are the same as those stated in the 2nd embodiment with corresponding values for the 4th embodiment.

TABLE 4
4th Embodiment

| | |
|---|---|
| L (mm) | 3.051 |
| OT (mm) | 0.455 |

The other details of the imaging lens assembly 200 have been described in the foregoing paragraphs of the 3rd embodiment and will not be described again herein.

### 5th Embodiment

FIG. 5A is a schematic view of an imaging lens assembly 300 according to the 5th embodiment of the present disclosure. In FIG. 5A, the imaging lens assembly 300 includes a dual molded lens barrel 301 and at least one lens element 380.

The dual molded lens barrel 301 includes a light transmitting portion 310 and a light absorbing portion 330. The light transmitting portion 310 includes an effective optical section 320, wherein an incident light passes through the effective optical section 320 and forms the image on an image surface (not shown herein).

The light absorbing portion 330 is connected to the light transmitting portion 310. A plastic material of the light absorbing portion 330 has the feature of absorbing visible light, and a color of the light absorbing portion 330 is black. A plastic material of the light transmitting portion 310 has the feature of being transmitted by visible light, and a color of the light transmitting portion 310 is transparent and colorless. Hence, the plastic material and the color of the light absorbing portion 330 are different from the plastic material and the color of the light transmitting portion 310. Furthermore, the light absorbing portion 330 includes a barrel section 350, wherein the lens element 380 is disposed in the barrel section 350.

An inner surface 354 of the barrel section 350 of the light absorbing portion 330 is connected to an outer surface 313 of the light transmitting portion 310. Furthermore, the inner surface 354 is firmly joined with the outer surface 313. Therefore, it is favorable for maintaining the structural strength of the dual molded lens barrel 301 after molding.

In detail, the dual molded lens barrel 301 has a waterproof function. The light transmitting portion 310 and the light absorbing portion 330 are formed by a dual-shot injection molding method.

FIG. 5B is a plane exploded view of the imaging lens assembly 300 according to FIG. 5A. In FIG. 5B, the effective optical section 320 of the light transmitting portion 310 has an object-side surface 321 being planar in a paraxial region and an image-side surface 322 being planar in a paraxial region.

In FIG. 5A and FIG. 5B, the outer surface 313 of the light transmitting portion 310 includes a groove 318. The groove 318 is a structure of the outer surface 313, which is recessed towards the effective optical section 320. Therefore, it is favorable for increasing the mold design margin of the injection molding equipment and improving the injection molding efficiency.

The light absorbing portion 330 can be passed through by an infrared light. When a transmittance of the light absorbing portion 330 for an incident light with a wavelength of 850 nm is T, the following condition is satisfied: T>75%. The inner surface 354 of the barrel section 350 is connected to an outer surface 383 of the lens element 380. That is, the lens element 380 is disposed in the barrel section 350. In addition, the lens element 380 has an object-side surface 381 being convex in a paraxial region and an image-side surface 382 being convex in a paraxial region.

The outer surface 383 of the lens element 380 includes a groove 388. The groove 388 is a structure of the outer surface 383, which is recessed towards an optical axis. Therefore, it is favorable for maintaining the unity of the injection molding equipment so as to reduce the manufacturing cost.

The light absorbing portion 330 further includes a light blocking section 340, wherein a diameter of an opening 349 of the light blocking section 340 is smaller than a diameter of the outer surface 313 of the light transmitting portion 310.

The imaging lens assembly 300 further includes a light blocking sheet 390, which is connected to and disposed in the barrel section 350 of the light absorbing portion 330. The light blocking sheet 390 is disposed between the effective optical section 320 of the light transmitting portion 310 and the lens element 380.

FIG. 5C is a three-dimensional exploded view of the imaging lens assembly 300 according to the 5th embodiment, and FIG. 5D is another three-dimensional exploded view of the imaging lens assembly 300 according to the 5th embodiment. In FIG. 5B, FIG. 5C and FIG. 5D, an opening 399 of the light blocking sheet 390 is an aperture stop of the imaging lens assembly 300. When a diameter of the opening 399 of the light blocking sheet 390 is d, the following condition is satisfied: 0.02 mm<d<0.15 mm.

The data of the parameters CT, L and OT of the imaging lens assembly 300 according to the 5th embodiment of the present disclosure are listed in the following Table 5, wherein the parameters are also shown as FIG. 5B. The definitions of these parameters shown in Table 5 are the same as those stated in the 1st embodiment with corresponding values for the 5th embodiment.

TABLE 5
5th Embodiment

| | |
|---|---|
| CT (mm) | 0.35 |
| L (mm) | 3.051 |
| OT (mm) | 0.473 |

### 6th Embodiment

FIG. 6 is a schematic view of an imaging lens module 31 according to the 6th embodiment of the present disclosure. In FIG. 6, the imaging lens module 31 includes the imaging lens assembly 300 in the aforementioned 5th embodiment and an image sensor 32. The image sensor 32 is disposed in the light absorbing portion 330 of the dual molded lens barrel 301 of the imaging lens assembly 300.

In FIG. 6 and the aforementioned 5th embodiment, the imaging lens module 31 includes the dual molded lens barrel 301 and the image sensor 32. The dual molded lens barrel 301 includes the light transmitting portion 310 and the light absorbing portion 330. The light transmitting portion 310 includes the effective optical section 320. The light absorbing portion 330 is connected to the light transmitting portion 310, wherein the plastic material and the color of the light absorbing portion 330 are different from the plastic material and the color of the light transmitting portion 310, and the light absorbing portion 330 includes an imaging section 360. The image sensor 32 is disposed in the imaging section 360. The image sensor 32 includes a cover glass 33 and an image surface 34, wherein the cover glass 33 is nearer an imaged object (not shown herein) than the image surface 34.

In FIG. 5B and FIG. 6, the light transmitting portion 310 and the light absorbing portion 330 are formed by the dual-shot injection molding method.

The outer surface 313 of the light transmitting portion 310 includes the groove 318. Therefore, it is favorable for increasing the mold design margin of the injection molding equipment for the light transmitting portion 310 and improving the injection molding efficiency.

The light absorbing portion 330 further includes the barrel section 350. The inner surface 354 of the barrel section 350 is connected to the outer surface 313 of the light transmitting portion 310. Therefore, it is favorable for maintaining the structural strength of the dual molded lens barrel 301 after molding.

The imaging lens module 31 further includes the at least one lens element 380 disposed in the barrel section 350.

The outer surface 383 of the lens element 380 includes the groove 388. Therefore, it is favorable for maintaining the unity of the injection molding equipment for the lens element 380 so as to reduce the manufacturing cost.

The light absorbing portion 330 further includes the light blocking section 340, wherein the diameter of the opening 349 of the light blocking section 340 is smaller than the diameter of the outer surface 313 of the light transmitting portion 310.

The imaging lens module 31 further includes the light blocking sheet 390 connected to the barrel section 350 of the light absorbing portion 330. The opening 399 of the light blocking sheet 390 is an aperture stop of the imaging lens module 31.

The data of the parameters L and OT of the imaging lens module 31 according to the 6th embodiment of the present disclosure are listed in the following Table 6, wherein the parameters are also shown as FIG. 5B. The definitions of these parameters shown in Table 6 are the same as those stated in the 2nd embodiment with corresponding values for the 6th embodiment.

TABLE 6
6th Embodiment

| | |
|---|---|
| L (mm) | 3.051 |
| OT (mm) | 0.473 |

The other details of the imaging lens assembly 300 have been described in the foregoing paragraphs of the 5th embodiment and will not be described again herein.

### 7th Embodiment

FIG. 7A is a schematic view of an imaging lens assembly 400 according to the 7th embodiment of the present disclosure. In FIG. 7A, the imaging lens assembly 400 includes a dual molded lens barrel 401 and at least one lens element 480.

The dual molded lens barrel 401 includes a light transmitting portion 410 and a light absorbing portion 430. The light transmitting portion 410 includes an effective optical section 420, wherein an incident light passes through the effective optical section 420 and forms the image on an image surface (not shown herein).

The light absorbing portion 430 is connected to the light transmitting portion 410. A plastic material of the light absorbing portion 430 has the feature of absorbing visible light, and a color of the light absorbing portion 430 is black. A plastic material of the light transmitting portion 410 has the feature of being transmitted by visible light, and a color of the light transmitting portion 410 is transparent and colorless. Hence, the plastic material and the color of the light absorbing portion 430 are different from the plastic material and the color of the light transmitting portion 410. Furthermore, the light absorbing portion 430 includes a barrel section 450, wherein the lens element 480 is disposed in the barrel section 450. An inner surface 454 of the barrel section 450 of the light absorbing portion 430 is connected to an outer surface 413 of the light transmitting portion 410.

In detail, the dual molded lens barrel 401 has a waterproof function. The light transmitting portion 410 and the light absorbing portion 430 are formed by a dual-shot injection molding method.

FIG. 7B is a plane exploded view of the imaging lens assembly 400 according to FIG. 7A. In FIG. 7B, an image-side surface 422 of the effective optical section 420 of the light transmitting portion 410 has diopter, wherein an object-side surface 421 of the effective optical section 420 is planar in a paraxial region, and the image-side surface 422 of the effective optical section 420 is concave in a paraxial region. Furthermore, the image-side surface 422 having diopter is aspheric. The outer surface 413 of the light transmitting portion 410 includes a groove 418.

In FIG. 7A and FIG. 7B, the light absorbing portion 430 can be passed through by an infrared light. When a transmittance of the light absorbing portion 430 for an incident light with a wavelength of 850 nm is T, the following condition is satisfied: T>75%. An inner surface 454 of the barrel section 450 is connected to an outer surface 483 of the lens element 480. That is, the lens element 480 is disposed in the barrel section 450. In addition, the lens element 480 has an object-side surface 481 being convex in a paraxial region and an image-side surface 482 being convex in a paraxial region. Furthermore, the outer surface 483 of the lens element 480 includes a groove 488.

The imaging lens assembly 400 further includes a light blocking sheet 490, which is connected to and disposed in the barrel section 450 of the light absorbing portion 430. The light blocking sheet 490 is disposed between the effective optical section 420 of the light transmitting portion 410 and the lens element 480.

FIG. 7C is a three-dimensional exploded view of the imaging lens assembly 400 according to the 7th embodiment. In FIG. 7B and FIG. 7C, an opening 499 of the light blocking sheet 490 is an aperture stop of the imaging lens assembly 400. When a diameter of the opening 499 of the light blocking sheet 490 is d, the following condition is satisfied: 0.02 mm<d<0.15 mm.

The data of the parameters CT, L and OT of the imaging lens assembly 400 according to the 7th embodiment of the present disclosure are listed in the following Table 7, wherein the parameters are also shown as FIG. 7B. The definitions of these parameters shown in Table 7 are the same as those stated in the 1st embodiment with corresponding values for the 7th embodiment.

TABLE 7
7th Embodiment

| | |
|---|---|
| CT (mm) | 0.45 |
| L (mm) | 2.0 |
| OT (mm) | 0.38 |

### 8th Embodiment

FIG. 8 is a schematic view of an imaging lens module 41 according to the 8th embodiment of the present disclosure. In FIG. 8, the imaging lens module 41 includes the imaging lens assembly 400 in the aforementioned 7th embodiment and an image sensor 42. The image sensor 42 is disposed in the light absorbing portion 430 of the dual molded lens barrel 401 of the imaging lens assembly 400.

In FIG. 8 and the aforementioned 7th embodiment, the imaging lens module 41 includes the dual molded lens barrel 401 and the image sensor 42. The dual molded lens barrel 401 includes the light transmitting portion 410 and the light absorbing portion 430. The light transmitting portion 410 includes the effective optical section 420. The light absorbing portion 430 is connected to the light transmitting portion 410, wherein the plastic material and the color of the light absorbing portion 430 are different from the plastic material and the color of the light transmitting portion 410, and the light absorbing portion 430 includes an imaging section 460. The image sensor 42 is disposed in the imaging section 460. The image sensor 42 includes a cover glass 43 and an image surface 44, wherein the cover glass 43 is nearer an imaged object (not shown herein) than the image surface 44.

In FIG. 7B and FIG. 8, the light transmitting portion 410 and the light absorbing portion 430 are formed by the dual-shot injection molding method. The image-side surface 422 of the effective optical section 420 of the light transmitting portion 410 has diopter, wherein the object-side surface 421 of the effective optical section 420 is planar in the paraxial region, and the image-side surface 422 of the effective optical section 420 is concave in the paraxial region. Furthermore, the image-side surface 422 having diopter is aspheric. The outer surface 413 of the light transmitting portion 410 includes the groove 418.

The light absorbing portion 430 further includes the barrel section 450. The inner surface 454 of the barrel section 450 is connected to the outer surface 413 of the light transmitting portion 410.

The imaging lens module 41 further includes the at least one lens element 480 disposed in the barrel section 450. Furthermore, the outer surface 483 of the lens element 480 includes the groove 488.

The imaging lens module 41 further includes the light blocking sheet 490 connected to the barrel section 450 of the light absorbing portion 430. The opening 499 of the light blocking sheet 490 is an aperture stop of the imaging lens module 41.

The data of the parameters L and OT of the imaging lens module 41 according to the 8th embodiment of the present disclosure are listed in the following Table 8, wherein the parameters are also shown as FIG. 7B. The definitions of these parameters shown in Table 8 are the same as those stated in the 2nd embodiment with corresponding values for the 8th embodiment.

TABLE 8
8th Embodiment

| | |
|---|---|
| L (mm) | 2.0 |
| OT (mm) | 0.38 |

The other details of the imaging lens assembly 400 have been described in the foregoing paragraphs of the 7th embodiment and will not be described again herein.

### 9th Embodiment

FIG. 9A is a schematic view of an imaging lens module 51 according to the 9th embodiment of the present disclosure. In FIG. 9A, the imaging lens module 51 includes a dual molded lens barrel 501 and an image sensor 52.

The dual molded lens barrel 501 includes a light transmitting portion 510 and a light absorbing portion 530. The light transmitting portion 510 includes an effective optical section 520, wherein an incident light passes through the effective optical section 520 and forms the image on an image surface 54.

The light absorbing portion 530 is connected to the light transmitting portion 510, wherein a plastic material and a color of the light absorbing portion 530 are different from a plastic material and a color of the light transmitting portion 510. In the 9th embodiment, the plastic material of the light absorbing portion 530 has the feature of absorbing visible light, and the color of the light absorbing portion 530 is black. The plastic material of the light transmitting portion 510 has the feature of being transmitted by visible light, and the color of the light transmitting portion 510 is transparent and colorless. Hence, the plastic material and the color of the light absorbing portion 530 are different from the plastic material and the color of the light transmitting portion 510. Furthermore, the light absorbing portion 530 includes an imaging section 560. The image sensor 52 is disposed in the imaging section 560. Therefore, it is favorable for maintaining the compact size and improving the image quality of the imaging lens module 51. In the 9th embodiment, the image sensor 52 includes a cover glass 53 and an image surface 54, wherein the cover glass 53 is nearer an imaged object (not shown herein) than the image surface 54.

In detail, the light transmitting portion 510 and the light absorbing portion 530 can be formed by a dual-shot injection molding method.

FIG. 9B is a plane exploded view of the imaging lens module 51 according to FIG. 9A. In FIG. 9A and FIG. 9B, at least one surface of an object-side surface 521 and an image-side surface 522 of the effective optical section 520 of the light transmitting portion 510 can have diopter. In the 9th embodiment, both of the object-side surface 521 and the image-side surface 522 of the effective optical section 520 of the light transmitting portion 510 have diopter, wherein the object-side surface 521 is convex in a paraxial region, and the image-side surface 522 is convex in a paraxial region.

Moreover, the surface having diopter of the object-side surface 521 and the image-side surface 522 of the effective optical section 520 of the light transmitting portion 510 can be aspheric. In the 9th embodiment, both of the object-side surface 521 having diopter and the image-side surface 522 having diopter are aspheric. Furthermore, an outer surface 513 of the light transmitting portion 510 can include a groove 518.

The light absorbing portion 530 can further include a barrel section 550. An inner surface 554 of the barrel section 550 is connected to the outer surface 513 of the light transmitting portion 510.

The light absorbing portion 530 can further include a light blocking section 540, wherein a diameter of an opening 549 of the light blocking section 540 is smaller than a diameter of the outer surface 513 of the light transmitting portion 510.

The imaging lens module 51 can further include a light blocking sheet 590 connected to the barrel section 550 of the light absorbing portion 530, wherein an opening 599 of the light blocking sheet 590 can be an aperture stop of the imaging lens module 51. In the 9th embodiment, the light blocking sheet 590 is disposed between the imaged object and the object-side surface 521 of the effective optical section 520.

The data of the parameters L and OT of the imaging lens module 51 according to the 9th embodiment of the present disclosure are listed in the following Table 9, wherein the parameters are also shown as FIG. 9B. The definitions of these parameters shown in Table 9 are the same as those stated in the 2nd embodiment with corresponding values for the 9th embodiment.

TABLE 9
9th Embodiment

| | |
|---|---|
| L (mm) | 2.571 |
| OT (mm) | 0.35 |

### 10th Embodiment

FIG. 10 shows an electronic device 60 according to the 10th embodiment of the present disclosure. The electronic device 60 of the 10th embodiment is an endoscopy, wherein the electronic device 60 includes an imaging lens module 61 according to the present disclosure. Therefore, it is favorable for obtaining the superior image quality so as to satisfy the requirements of high-end electronic devices with camera functionalities. In addition, it is favorable for being applicable to medical devices. Furthermore, the imaging lens module 61 includes an imaging lens assembly (not shown herein) according to the present disclosure and an image sensor (not shown herein), wherein the image sensor is disposed in the light absorbing portion (not shown herein) of the imaging lens assembly. Preferably, the electronic device 60 can further include but not limited to a display, a control unit, a storage unit, a random access memory unit (RAM), a read-only memory unit (ROM) or a combination thereof.

### 11th Embodiment

FIG. 11 shows an electronic device 70 according to the 11th embodiment of the present disclosure. The electronic device 70 of the 11th embodiment is a smart phone, wherein the electronic device 70 includes an imaging lens module 71 according to the present disclosure.

### 12th Embodiment

FIG. 12 shows an electronic device 80 according to the 12th embodiment of the present disclosure. The electronic device 80 of the 12th embodiment is a tablet personal computer, wherein the electronic device 80 includes an imaging lens module 81 according to the present disclosure.

### 13th Embodiment

FIG. 13 shows an electronic device 90 according to the 13th embodiment of the present disclosure. The electronic device 90 of the 13th embodiment is a wearable device, wherein the electronic device 90 includes an imaging lens module 91 according to the present disclosure.

Although the present disclosure has been described in considerable detail with reference to the embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims.

What is claimed is:

1. An imaging lens assembly, comprising:
a dual molded lens barrel comprising:
a light transmitting portion comprising an effective optical section; and
a light absorbing portion connected to the light transmitting portion, wherein a plastic material and a color of the light absorbing portion are different from a plastic material and a color of the light transmitting portion, and the light absorbing portion comprises a barrel section; and
at least one lens element disposed in the barrel section.

2. The imaging lens assembly of claim 1, wherein the light transmitting portion and the light absorbing portion are formed by a dual-shot injection molding method.

3. The imaging lens assembly of claim 2, wherein an inner surface of the barrel section is connected to an outer surface of the lens element.

4. The imaging lens assembly of claim 2, wherein an inner surface of the barrel section is connected to an outer surface of the light transmitting portion.

5. The imaging lens assembly of claim 1, wherein a central thickness of the effective optical section of the light transmitting portion is OT, and the following condition is satisfied:
0.10 mm<OT<0.90 mm.

6. The imaging lens assembly of claim 1, wherein a central thickness of the lens element is CT, and the following condition is satisfied:
0.12 mm<CT<0.90 mm.

7. The imaging lens assembly of claim 1, wherein a length parallel to an axial axis of the dual molded lens barrel is L, and the following condition is satisfied:
1.0 mm<L<7.5 mm.

8. The imaging lens assembly of claim 1, wherein the dual molded lens barrel has a waterproof function.

9. The imaging lens assembly of claim 1, wherein the light absorbing portion can be passed through by an infrared light, a transmittance of the light absorbing portion for an incident light with a wavelength of 850 nm is T, and the following condition is satisfied:
T>75%.

10. The imaging lens assembly of claim 1, wherein at least one surface of an object-side surface and an image-side surface of the effective optical section of the light transmitting portion has diopter.

11. The imaging lens assembly of claim 10, wherein the surface is aspheric.

12. The imaging lens assembly of claim 1, further comprising:
a light blocking sheet connected to the barrel section.

13. The imaging lens assembly of claim 12, wherein an opening of the light blocking sheet is an aperture stop of the imaging lens assembly.

14. The imaging lens assembly of claim 13, wherein a diameter of the opening of the light blocking sheet is d, and the following condition is satisfied:
0.02 mm<d<0.15 mm.

15. The imaging lens assembly of claim 12, wherein the light blocking sheet is disposed between the effective optical section of the light transmitting portion and the lens element.

16. The imaging lens assembly of claim 2, wherein the light absorbing portion further comprises:
a light blocking section, wherein a diameter of an opening of the light blocking section is smaller than a diameter of an outer surface of the light transmitting portion.

17. The imaging lens assembly of claim 16, wherein the opening of the light blocking section is an aperture stop of the imaging lens assembly.

18. The imaging lens assembly of claim 2, wherein an outer surface of the light transmitting portion comprises a groove.

19. The imaging lens assembly of claim 2, wherein an outer surface of the lens element comprises a groove.

20. An electronic device, comprising:
an imaging lens module comprising:
the imaging lens assembly of claim 1; and
an image sensor, wherein the image sensor is disposed in the light absorbing portion of the imaging lens assembly.

21. The electronic device of claim 20, wherein the electronic device is an endoscopy.

22. An imaging lens module, comprising:
a dual molded lens barrel comprising:
a light transmitting portion comprising an effective optical section; and
a light absorbing portion connected to the light transmitting portion, wherein a plastic material and a color of the light absorbing portion are different from a plastic material and a color of the light transmitting portion, and the light absorbing portion comprises an imaging section; and
an image sensor disposed in the imaging section.

23. The imaging lens module of claim 22, wherein the light transmitting portion and the light absorbing portion are formed by a dual-shot injection molding method.

24. The imaging lens module of claim 22, further comprising:
a light blocking sheet connected to the light absorbing portion, wherein an opening of the light blocking sheet is an aperture stop of the imaging lens module.

25. The imaging lens module of claim 22, wherein the light absorbing portion further comprises:
a barrel section, wherein an inner surface of the barrel section is connected to an outer surface of the light transmitting portion.

26. The imaging lens module of claim 22, wherein at least one surface of an object-side surface and an image-side surface of the effective optical section of the light transmitting portion has diopter.

27. The imaging lens module of claim 26, wherein the surface is aspheric.

28. The imaging lens module of claim 25, further comprising:
at least one lens element disposed in the barrel section.

29. The imaging lens module of claim 28, wherein an outer surface of the lens element comprises a groove.

30. The imaging lens module of claim 23, wherein the light absorbing portion further comprises:
a light blocking section, wherein a diameter of an opening of the light blocking section is smaller than a diameter of an outer surface of the light transmitting portion.

31. The imaging lens module of claim 30, wherein the opening of the light blocking section is an aperture stop of the imaging lens module.

32. The imaging lens module of claim 23, wherein an outer surface of the light transmitting portion comprises a groove.

33. The imaging lens module of claim 22, wherein a central thickness of the effective optical section of the light transmitting portion is OT, and the following condition is satisfied:
0.10 mm<OT<0.90 mm.

34. The imaging lens module of claim 22, wherein a length parallel to an axial axis of the dual molded lens barrel is L, and the following condition is satisfied:
1.0 mm<L<7.5 mm.

35. An electronic device, comprising:
the imaging lens module of claim 22.

36. The electronic device of claim 35, wherein the electronic device is an endoscopy.
